(19) United States
(12) Patent Application Publication
(10) Pub. No.: US 2024/0269558 A1
(43) Pub. Date: Aug. 15, 2024

(54) PROGRAM, INFORMATION PROCESSING DEVICE, METHOD, AND SYSTEM

(71) Applicant: CYGAMES, INC., Tokyo (JP)

(72) Inventors: Tomohiro Kawakami, Tokyo (JP); Takafumi Goto, Tokyo (JP); Kazuki Miyasaka, Tokyo (JP)

(73) Assignee: CYGAMES, INC., Tokyo (JP)

(21) Appl. No.: 18/486,975

(22) Filed: Oct. 13, 2023

Related U.S. Application Data
(63) Continuation of application No. PCT/JP2022/007364, filed on Feb. 22, 2022.

(30) Foreign Application Priority Data
Apr. 15, 2021 (JP) 2021-068840

(51) Int. Cl. A63F 13/5375; A63F 13/525; A63F 13/54

(52) U.S. Cl. CPC A63F 13/5375; A63F 13/525; A63F 13/54

(57) ABSTRACT

An information processing device 10 is includes: a game presentation processing unit 23d that executes processing of presenting the game on the basis of game-status information of the game; a production-information decision unit 23e that decides game production information indicating game development on the basis of the game-status information of the game; and an action-related-information decision unit 23f that decides action-related information serving as information related to an action of any of the one or more game media that is associated with the game production information. When executing the processing of presenting the game, the game presentation processing unit 23d processes the game production information and causes said any of the one or more game media to act on a game screen, on the basis of the game production information and the action-related information on said any of the one or more game media.

### TECHNICAL FIELD

The present invention relates to a program etc. and particularly relates to a program etc. for a game in which one or more game media participate.

### BACKGROUND ART

In recent years, electronic devices such as smartphones have rapidly become widespread, and a large number of games to be executed on such electronic devices have been released. Among these kinds of games, there is a known racing game in which a plurality of game media such as racehorses are made to participate in a race to compete for a place against each other (for example, see PTL 1).

### Citation List

### Patent Literature

[PTL 1] Japanese Unexamined Patent Application, Publication No. 2009-045353

### SUMMARY OF INVENTION

### Technical Problem

In this kind of game, a sense of presence in the game can be created by applying production effects for the game status, such as a live report However, there is a problem in that game media just perform an action, e.g., running, necessary to proceed with the game, thus resulting in a lack of excitement. This problem applies not only to racing games but also to all games with a sense of presence in which game media act, such as sports match games and fighting match games.

The present invention has been made in order to solve such a problem, and an object thereof is to provide a program, an information processing device, a method, and a system capable of enhancing the sense of presence in a game.

### Solution to Problem

According to one aspect, the present invention provides a program for a game in which one or more game media participate, the program causing a computer to function as: a game presentation processing means that executes processing of presenting the game on the basis of game-status information of the game; a production-information decision means that decides game production information indicating game development on the basis of the game-status information of the game; and an action-related-information decision means that decides action-related information serving as information related to an action of any of the one or more game media that is associated with the game production information, wherein, when executing the processing of presenting the game, the game presentation processing means processes the game production information and causes said any of the one or more game media to act on a game screen, on the basis of the game production information and the action-related information on said any of the one or more game media.

According to another aspect, the present invention provides an information processing device that executes a game in which one or more game media participate, the information processing device including: a game presentation processing means that executes processing of presenting the game on the basis of game-status information of the game; a production-information decision means that decides game production information indicating game development on the basis of the game-status information of the game; and an action-related-information decision means that decides action-related information serving as information related to an action of any of the one or more game media that is associated with the game production information, wherein, when executing the processing of presenting the game, the game presentation processing means processes the game production information and causes said any of the one or more game media to act on a game screen, on the basis of the game production information and the action-related information on said any of the one or more game media.

According to still another aspect, the present invention provides a method for an information processing device to execute a game in which one or more game media participate, the method including: a game presentation processing step for executing processing of presenting the game on the basis of game-status information of the game; a production-information decision step for deciding game production information indicating game development on the basis of the game-status information of the game; and an action-related-information decision step for deciding action-related information serving as information related to an action of any of the one or more game media that is associated with the game production information, wherein, in the game presentation processing step, when the processing of presenting the game is executed, the game production information is processed, and said any of the one or more game media is made to act on a game screen, on the basis of the game production information and the action-related information on said any of the one or more game media.

According to still another aspect, the present invention provides a system for executing a game in which one or more game media participate, the system including an electronic device and a server connected to the electronic device via a network, the electronic device or the server functioning as a game presentation processing means that executes processing of presenting the game on the basis of game-status information of the game; the electronic device or the server functioning as a production-information decision means that decides game production information indicating game development on the basis of the game-status information of the game; and the electronic device or the server functioning as an action-related-information decision means that decides action-related information serving as information related to an action of any of the one or more game media that is associated with the game production information, wherein, when executing the processing of presenting the game, the game presentation processing means processes the game production information and causes said any of the one or more game media to act on a game screen, on the basis of the game production information and the action-related information on said any of the one or more game media.

### Advantageous Effects of Invention

According to the present invention, the sense of presence in a game can be enhanced.

### BRIEF DESCRIPTION OF DRAWINGS

FIG. 1 is a block diagram showing the hardware configuration of an information processing device according to an embodiment of the present invention.

FIG. 2 shows one example of a functional block diagram of the information processing device according to the embodiment of the present invention.

FIG. 3 shows one example of a functional block diagram of a game control unit.

FIG. 4 shows one example of a game-media selection screen.

FIG. 5 shows one example of a game screen generated by a game presentation processing unit, which is also one example of a game screen generated before a motion change.

FIG. 6 shows one example of a game screen generated by the game presentation processing unit, which is also one example of a game screen generated after the motion change.

FIG. 7 shows one example of an operation flowchart, related to production and an action, of the information processing device according to the embodiment of the present invention.

FIG. 8 shows one example of an operation flowchart, related to a motion change, of the information processing device according to the embodiment of the present invention.

FIG. 9 is a view showing one example of the overall configuration of a game system according to an embodiment of the present invention.

### DESCRIPTION OF EMBODIMENTS

A game system according to an embodiment of the present invention will be described below with reference to the accompanying drawings. In this specification, for convenience of description, there are cases where descriptions that are more detailed than necessary are omitted. For example, there are cases where detailed descriptions of matters that are already well known and repeated descriptions of substantially the same configurations are omitted.

Although this game system can be realized by a system in which a plurality of information processing devices are connected via a network, this game system can also be realized by one information processing device. First, an embodiment realized by one information processing device will be described, and a system connected to a network will be described next.

### Embodiment Realized By Information Processing Device

### Configuration

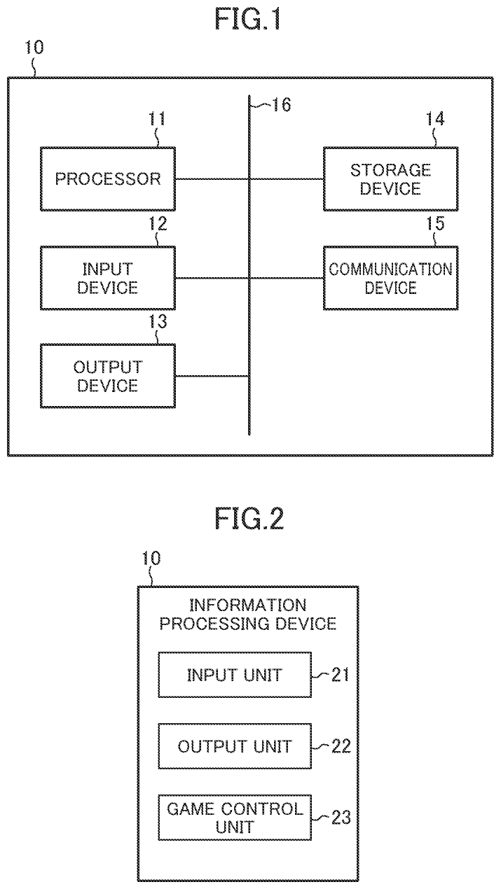

FIG. 1 is a block diagram showing the hardware configuration of an information processing device 10 according to an embodiment of the present invention. The information processing device 10 includes a processor 11, an input device 12, an output device 13, a storage device 14, and a communication device 15. The individual constituents 11 to 15 are connected via a bus 16. Note that it is also possible that interfaces are interposed as needed between the bus 16 and the individual constituents 11 to 15. In this embodiment, the information processing device 10 is a smartphone. Alternatively, the information processing device 10 can also be a computer, such as a tablet computer, a laptop computer, or a desktop computer, as long as the computer includes the configuration described above.

The processor 11 controls the overall operation of the information processing device 10 and is, for example, an electronic circuit such as a CPU or an MPU. The processor 11 executes various kinds of processing by loading programs and data stored in the storage device 14 and executing the programs. In one example, the processor 11 is constituted of a plurality of processors.

The input device 12 is a user interface for accepting inputs to the information processing device 10 from the user; for example, the input device 12 is a touch panel, a touchpad, a keyboard, or a mouse. Since the information processing device 10 of this embodiment is a smartphone, the information processing device 10 includes a touch panel, and this touch panel functions as the input device 12 and the output device 13 (display device). The input device 12 and the output device 13 may have separate forms disposed at different positions.

The output device 13 presents application screens, sound, etc., to the user of the information processing device 10, that is, a player, under the control of the processor 11. The output device 13 can include, for example, a display device such as a liquid crystal display, an organic EL display, or a plasma display, an audio device such as a speaker that emits a sound, and/or a haptic device that vibrates the information processing device 10.

The storage device 14 is a storage device that includes a main memory, a buffer memory, and a storage and that is included in a general smartphone or computer, such as a magnetic storage device and a storage device that use a RAM, which is a volatile memory, and a flash memory, which is a non-volatile memory, such as an eMMC, a UFS, or an SSD. The storage device 14 can include an external memory. The storage device 14 stores, for example, a game application. The game application includes a game program for executing a game and various kinds of data and various kinds of tables to be referred to when the game program is executed. The game program is activated in accordance with an operation of the user with respect to the information processing device 10 and is executed on an operating system (OS) implemented in advance in the information processing device 10.

In one example, the storage device 14 includes a main storage device and an auxiliary storage device. The main storage device is a volatile storage medium that allows high-speed reading and writing of information and is used as a storage area and a work area when the processor 11 processes information. The auxiliary storage device stores various programs and data that is used by the programs when the programs are executed. Although the auxiliary storage device is, for example, an SSD or a hard disk device, the auxiliary storage device may be any type of non-volatile storage or non-volatile memory that is capable of storing information and may be detachable. The auxiliary storage device stores, for example, an operating system (OS), middleware, application programs, and various kinds of data that may be referred to when these programs are executed.

The communication device 15 sends data to and receives data from other computers, such as a server, via the network. For example, the communication device 15 performs wireless communication, such as mobile communication or wireless LAN communication, to connect to the network. In one example, the information processing device 10 downloads a program from the server by means of the communication device 15 and stores the program in the storage device 14. Alternatively, the communication device 15 may perform wired communication using an Ethernet (registered trademark) cable or the like. In the case where data is not sent to or received from another computer, the information processing device 10 need not include the communication device 15.

FIG. 2 shows one example of a functional block diagram of the information processing device 10 according to the embodiment of the present invention. The information processing device 10 includes an input unit 21, an output unit 22, and a game control unit 23. In this embodiment, these functions are realized when the processor 11 executes a program. For example, the program to be executed is the game program stored in the storage device 14 or received via the communication device 15. Since the various kinds of functions are realized by loading the program, as described above, a portion or the entirety of one part (function) may be included in another part. The various kinds of functions are realized as individual means through execution of the program. Alternatively, these functions may be realized by means of hardware by configuring electronic circuits or the like each realizing a portion or the entirety of each of the functions.

The input unit 21 is configured by using the input device 12 and accepts inputs to the information processing device 10 from the user. In this embodiment, a touch detection function included in the touch panel and generally included in the smartphone can be used.

The output unit 22 is configured by using the output device 13 and outputs, to the output device 13, game screens, sounds, or vibrations corresponding to the proceeding of the game and user operations. The game control unit 23 performs basic control when the game of this embodiment is executed. The game is a game in which one or more game media participate. The game of this embodiment is a racing game, like a horse-racing game, in which characters of a plurality of game media run a predetermined course for a predetermined distance to compete for a place, and the order of finish of the plurality of game media is decided. The game media are electronic data used in the game, such as characters or equipped items like weapons, items, and cards. The game media in this embodiment are characters and are associated with IDs that uniquely identify the characters and with images, objects, and characteristic information that indicate the characters and that are displayed on the output device 13. The characteristic information is information indicating characteristics of the game media and is, for example, information related to skills and parameters indicating the abilities of the characters.

The game control unit 23 decides a game in which one or more game media participate and a game medium (or media) to be made to participate in this game and executes this game. Then, game control unit 23 outputs, to the output device 13, game screens etc. to be presented to the player, on the basis of game-status information serving as an execution result of the game, to present the game status and development to the player. That is, the game control unit 23 separately performs game execution processing and presentation processing that is related to a production of an execution result for presenting the execution result to the player.

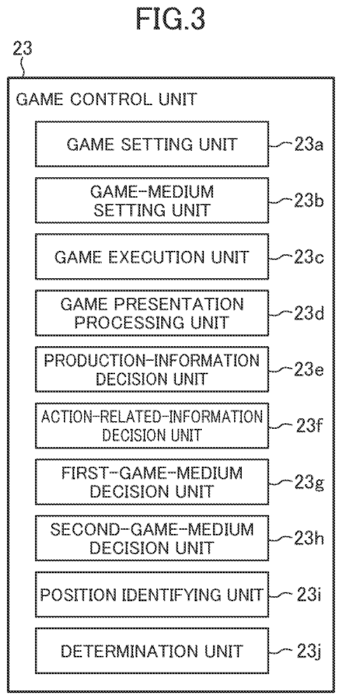

FIG. 3 shows one example of a functional block diagram of the game control unit. As shown in FIG. 3, the game control unit 23 includes a game setting unit 23a, a game-medium setting unit 23b, a game execution unit 23c, a game presentation processing unit 23d, a production-information decision unit 23e, an action-related-information decision unit 23f, a first-game-medium decision unit 23g, a second-game-medium decision unit 23h, a position identifying unit 23i, and a determination unit 23j.

The game setting unit 23a decides a game to be executed at the game execution unit 23c. In one example, the game setting unit 23a displays, on the output device 13, a game selection screen (not shown) for accepting a player's selection from among multiple kinds of games, and decides the selected game as a game to be executed. In the game selection screen of this embodiment, a plurality of racing games each consisting of a combination of the distance, such as a short distance, a mile, a medium distance, or a long distance, and the racetrack, such as turf or dirt, can be choices of a game to be executed. In another example, the game setting unit 23a randomly decides one game from among the multiple kinds of games (here, racing games), as a game to be executed.

The game-medium setting unit 23b is configured by including the processor 11, the input device 12, the output device 13, and the storage device 14, and sets game media to be used in the game (hereinafter, also referred to as “used game media”). For example, the game-medium setting unit 23b sets a game medium (or media) selected from a game-medium group by the player, as a used game medium (or media) to be made to participate (to be used) in the game. The game-medium group is a group of game media configured by including a plurality of game media. The individual game media in the game-medium group are, for example, game media possessed by the player and serve as choices from which the player selects a used game medium (or media) to be used in a racing game. Although the game media are stored in advance in the storage device 14 in this embodiment, the game media may also be obtained from another player via the communication device 15 or may also be trained by the player himself/herself in a training game in which game media that could be included in a game are trained.

In addition to a game medium (or media) selected by the player, the game-medium setting unit 23b may also set a game medium (or media) selected by another player by accepting the selection via the communication device 15 and/or may also set a non-player character(s) (NPC(s)) at random, as used game media to be made to participate in a game. That is, the game-medium setting unit 23b may assign a game medium (or media) selected by the player to one or more of N game media that can participate in a game (for example, N=18) and assign a game medium (or media) selected by another player and/or an NPC(s) to the remaining.

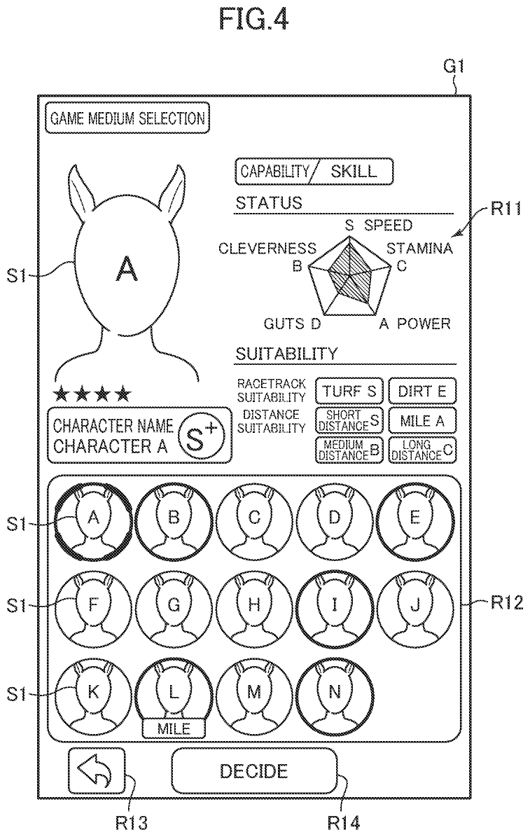

FIG. 4 shows one example of a game-media selection screen G1. As shown in FIG. 4, the game-medium setting unit 23b causes the game-media selection screen G1 to be displayed on the output device 13 and accepts a player's selection of a game medium via the input device 12. The game-media selection screen G1 contains a selected-game-medium display region R11, a game-media-group display region R12, a return button R13, and a decision button R14.

The game-media-group display region R12 displays images S1 of a plurality of game media (here, characters A to N) possessed by the player. The plurality of game media constitute the game-medium group. In this embodiment, since the output device 13 and the input device 12 are configured by the touch panel of the information processing device 10, a selection of one of the game media displayed in the game-media-group display region R12 can be accepted with a finger or the like of the player.

The selected-game-medium display region R11 includes and displays an image and characteristic information of a game medium selected from among the plurality of game media. The characteristic information includes: for example, fundamental-capability parameters indicating the speed, the stamina, the power, the guts, and the cleverness; suitability parameters including racetrack suitability and distance suitability; and skills. The racetrack suitability includes, for example, suitability for turf and suitability for dirt, and the distance characteristic includes, for example, a short-distance characteristic, a mile characteristic, a medium-distance characteristic, and a long-distance characteristic. The individual parameters are, for example, numerical values. In one example, together with the numerical values or instead of the numerical values, ranks or levels can be displayed with A, B, C, and so on, in accordance with stages. For example, a rank S shows the highest suitability, and the suitability is gradually reduced in the order of ranks S, A, B, C, etc. In one example, when the parameter of the speed is displayed with the rank S, that shows a high-speed characteristic, and, when the parameter of the speed is displayed with a rank F, that shows a low-speed characteristic.

With a “capability” tab in the selected-game-medium display region R11, the fundamental-capability parameters and the suitability parameters are displayed, as shown in FIG. 4, and, with a “skill” tab, information related to skills linked with the selected game medium is displayed.

The return button R13 is a screen used to return to the game selection screen, for example, and the decision button R14 is a button used to decide game media selected in the game-media-group display region R12, as used game media to be made to participate in the game.

The game execution unit 23c executes the game decided by the game setting unit 23a, on the basis of the used game media set by the game-medium setting unit 23b. That is, the game execution unit 23c generates game-status information serving as an execution result of the game, through the execution of the game based on the characteristic information on the individual used game media. The generated game-status information may be temporarily stored in the storage device 14, such as a memory, or may be output to a required constituent(s).

The game-status information is information or data indicating the status, the progression, and/or the development of the game, including location information of one or more used game media in a virtual space of the game per unit time. The game-status information may include, in addition to the location information, speed information, place information, and/or skill exercise information of one or more used game media in the virtual space of the game per unit time. The location information is position coordinate data of each of the used game media at a certain virtual time in the virtual space of the game. The speed information may be differential value data of the position coordinates of each of the used game media or may be data of the value obtained by dividing the difference between the position coordinates at a certain virtual time and the position coordinates at a virtual time immediately before by a unit time. The place information is data indicating the place out of all the used game media at a certain virtual time in the virtual space of the game. The skill exercise information includes: data indicating whether a skill of each of the used game media has been exercised at a certain virtual time in the virtual space of the game; and data indicating the effect (for example, the amount of speed up, the amount of stamina recovery, or the like) associated with the exercise of the skill.

In one example, the game-status information can be shown in a table in which the horizontal axis (column) indicates the type of a used game medium and in which the vertical axis (row) indicates time. When the number of used game media that can be made to participate in a game to be executed is set to N (here, N=18), individual columns can indicate individual used game media j (j=1, 2, . . ., 18), and individual rows can include location information, speed information, etc., of the used game media j at a certain virtual time. That is, the game-status information can be shown in a matrix M, and matrix elements Mij of i rows and j columns can include the location information, the speed information, the place information, and the skill exercise information of the used game media j at a certain virtual time ti in the virtual space of the game.

In another example, the game-status information may be a row itself in the above-described table (matrix M), i.e., data for a unit time, or may be data for one game.

The game presentation processing unit 23d is configured by including the processor 11, the output device 13, and the storage device 14 and executes processing of presenting the game on the basis of the game-status information of the game. The game presentation processing unit 23d generates presentation information, such as game screens, to be presented to the player, and outputs the presentation information to the output device 13. Details of the game presentation processing unit 23d will be described later. Note that, even if the speed information and the place information of a used game medium (or media) are not included in the game-status information, the game presentation processing unit 23d can calculate, from the location information of one or more used game media in the virtual space of the game per unit time, and decide the speed information and the place information of the one or more used game media at each virtual time.

The production-information decision unit 23e decides game production information on the basis of the game-status information of the game. The game production information is information indicating the development, the progression, and/or the status of the game and is, for example, sound information or text information. In one example, the game production information includes live-report/commentary sound information and/or live-report/commentary caption information on the game. The live-report/commentary sound information is sound data of a reporter and/or a commentator for showing the player the development, the progression, and/or the status of the game, and is output from the audio device such as a speaker included in the output device 13 on the basis of the data. The live-report/commentary sound information is sound data indicating that, for example, “the leading used game medium j is running alone!”, “the 2nd-place used game medium j is trying to overtake the leading used game medium i!”, “the used game medium j is putting on a last spurt!”, “the used game medium j is tired!”, or the like. The live-report/commentary caption information is text data of the reporter and/or the commentator for showing the player the development, the progression, and/or the status of the game, and is output to the display device such as a display included in the output device 13. Although the live-report/commentary sound information and the live-report/commentary caption information have different data formats, they can have the same content. Note that “used game medium i” and “used game medium j”, which are used here as examples, can be replaced with the character names of the corresponding used game media on the basis of the game-status information, for example, by the game presentation processing unit 23d.

Specifically, in the case where a predetermined first game-status condition is satisfied on the basis of the game-status information, the production-information decision unit 23e decides game production information corresponding to the first game-status condition. The game production information is stored in the storage device 14 in association with the first game-status condition.

The first game-status condition is a condition showing a predetermined game status and serving as a trigger, here, for deciding the game production information. The production-information decision unit 23e can determine whether this condition is satisfied on the basis of the game-status information. In the case of the game production information indicating that “the leading used game medium j is running alone!”, for example, the first game-status condition can be set to a status in which the used game medium j in the 1st place is away from the used game medium i in the 2nd place for a predetermined distance or longer for a predetermined period of time. Furthermore, in another example, in the case of the game production information indicating that “the 2nd-place used game medium j is trying to overtake the leading used game medium i!”, the first game-status condition can be set to predetermined changes in position coordinates and speed between the used game medium in the 1st-place and the used game medium in the 2nd-place, for a predetermined period of time. In the case of the game production information indicating that “the used game medium j is tired!”, the first game-status condition can be set to a status in which, even though the places of the individual used game media do not change for a predetermined period of time, the relative position of the used game medium j comes closer to the trailing used game medium, i.e., a change in relative position per predetermined period of time. Furthermore, the first game-status condition can be: (1) a condition that a particular game medium is in a specific status during the game, e.g., entering the gate, an early stage, a middle stage, or a final stage; (2) a condition that a particular game medium has exercised a skill; (3) a condition that a particular game medium was affected by a skill of another game medium; (4) a condition that a particular game medium is in a specific state, e.g., excitement, fear, or being pushed out; (5) a condition that a fundamental-capability parameter of the speed, the stamina, or the like of a particular game medium becomes a predetermined value; (6) a condition that a parameter indicating the type of the game field (background), the weather or the state of the virtual space, or the like becomes a predetermined value; (7) a condition that a reuse-prohibited flag is not set for game production information, in a game in which, once game production information is processed, a reuse-prohibited flag is set for that game production information by, for example, the game control unit 23; or a combination of at least two of the conditions. In this way, a plurality of first game-status conditions are set, and the game production information and each of the first game-status conditions are stored in association with each other.

Note that, in the case where the game presentation processing unit 23d is not processing game production information, the production-information decision unit 23e of this embodiment decides game production information. In one example, the game control unit 23 determines whether the game presentation processing unit 23d is processing game production information, and the production-information decision unit 23e obtains the determination result, thereby making it possible to determine whether the game presentation processing unit 23d is processing game production information.

The action-related-information decision unit 23f is configured by including the processor 11 and the storage device 14 and decides action-related information on a game medium associated with the game production information. The action-related information is information related to an action of a game medium, and can include motion change information on the game medium, expression change information thereon, texture change information thereon, or a combination of at least two of these pieces of information. The action-related information can include additional actions other than a fixed action such as a running action related to progression of the game. Examples of the additional actions can be actions indicated by motion change information and display change information. The action-related information is stored in the storage device 14 in association with game production information. The action-related-information decision unit 23f decides action-related information associated with game production information decided by the production-information decision unit 23e.

The motion change information is information indicating changes in movement of a game medium (used game medium) during the game progression. Here, in the case where a game medium (character) is displayed by using 3D computer graphics etc., one or more objects (for example, polygons and/or images) corresponding to the shape of the character are drawn in combination, and texture change information representing the texture etc. of the character is mapped on the surfaces of the objects, thereby making it possible to express the character in the game screen.

Since this embodiment shows a racing game for racing, the motion change information is information indicating changes in movement of a part of a game medium, other than a running action. The part of a game medium can be, for example, a part of the body of the game medium, such as the face, the eyes, the head, the neck, the breast, or the hip. The part of a game medium may be a part of the body in the midline of the game medium, in other words, may be a part that does not affect the running action, like a part, such as the face, the eyes, the head, the neck, the breast, or the hip, excluding at least the legs related to the running action. Furthermore, the part of a game medium can be a part of the game medium enabling the game medium to detect another game medium and/or a part of the game medium related to the detection. The part of a game medium enabling detection of another game medium can be, for example, eyes, a sensor, a tentacle, an antenna, a radar, or the like of the game medium. The part of the game medium related to the detection is a part that supports the part of the game medium enabling detection of another game medium and can be, for example, the face, the head, the body, or the like of the game medium.

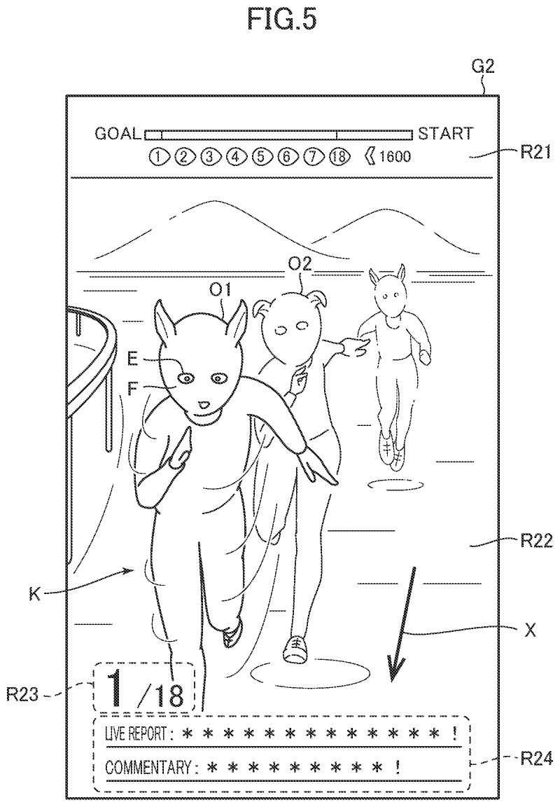

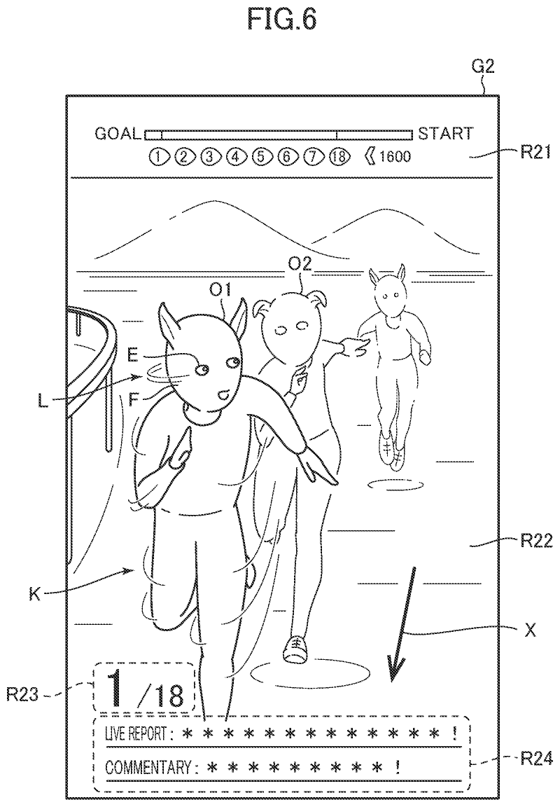

In one example, the motion change information can include information or data indicating a turning action (hereinafter, also referred to as a “glance motion”) of turning a part of the body, including the face and/or the eyes, of a left, right, and/or trailing game medium toward another game medium, and information or data indicating an action of returning to the original state after the turning action. Note that the positional relationship and the direction of the left, the right, and/or the trailing game medium are determined on the basis of a game medium that performs an action. FIG. 5 shows one example of a game screen generated by the game presentation processing unit 23d, which is also one example of a game screen generated before a glance motion is performed. FIG. 6 shows one example of a game screen generated by the game presentation processing unit 23d, which is also one example of a game screen generated after the glance motion is performed. As shown in FIG. 5, it is found that the face and the eyes of the leading game medium are turned toward the left rear side, and the leading game medium checks a game medium on the left rear side. In the example shown in FIG. 6, motion change information on the leading game medium includes a glance motion toward the left rear side and an action of returning to the original state (that is, facing straight in the traveling direction). In another example, motion change information can include an action of wiping sweat with a hand.

The expression change information is information indicating a change in expression of a game medium. For example, the expression change information includes image data of a normal expression and image data of changed expressions of a game medium, such as a tired expression, an impatient expression, a fearless-smile expression, a desperate expression, and a motivated expression in overtaking the front game medium in the last spurt or the like. In the case where the game production information indicates that “the 2nd-place used game medium j is trying to overtake the leading used game medium i!” or “the used game medium j is putting on a last spurt!”, the expression change information includes image data of a desperate expression or a motivated expression. In the case where the game production information indicates that “the used game medium j is tired!”, the expression change information includes image data of a tired expression. Note that a change in expression of a game medium may be realized by a motion change of a face part of the game medium or a texture change of the face part.

The texture change information is texture data indicating the textures etc. of a game medium and/or the textures etc. of the surroundings of the game medium in the game screen, and can include pieces of data before and after a change in the textures etc. The texture change information can be image data indicating: a blur (for example, indicated by reference symbol L in FIG. 6) with which the game medium and/or the ground of the race track and facilities of the race track that are seen around the game medium look unclear or blurred due to a high running speed of the game medium; and an effect for cutting the wind (for example, indicated by reference symbol K in FIGS. 5 and 6). In the case where the game production information indicates that, for example, “the 2nd-place used game medium j is trying to overtake the leading used game medium i!”, the texture change information can include image data of blurring the used game medium j and its surroundings and image data of the effect for cutting the wind, so as to show that the running speed of the 2nd-place used game medium j is high when the 2nd-place used game medium j overtakes the leading used game medium i.

As described above, the action-related information may include the motion change information, the expression change information, and the texture change information, for example, may include, as the motion change information, information indicating an action of turning to the left, the right, and/or the rear side and an action of returning to the original state, and also include, as the expression change information, image data of an expression with a fearless smile after the actions of turning and returning to the original state. This action-related information can be decided by the action-related-information decision unit 23f as action-related information to be processed by the game presentation processing unit 23d, in the case where, for example, a first game-status condition that the leading used game medium is away from the 2nd-place game medium for a predetermined distance or longer for a predetermined period of time is satisfied. Combinations and permutations of pieces of information included in the action-related information can be appropriately set in advance in accordance with assumed game statuses and can be stored in the storage device 14.

The first-game-medium decision unit 23g is configured by including the processor 11 and the storage device 14 and decides, among the plurality of game media, a first game medium to be displayed on the game screen and action information, on the basis of a predetermined condition.

The predetermined condition is a second game-status condition indicating a predetermined game status, here, a condition serving as a trigger for deciding a first game medium and action information. The second game-status condition is a kind of the first game-status condition and is a condition indicating a game status for exercising a glance motion. A first example of the second game-status condition shows a status in which the leading game medium is away from the trailing game medium (for example, the 2nd-place game medium) for a predetermined distance or longer for a predetermined period of time and in which the leading game medium is running alone with the trailing game medium being left behind. A second example of the second game-status condition shows a status in which the distance between a certain game medium (for example, the leading game medium) and a trailing game medium (for example, the 2nd-place game medium) in the traveling direction is narrowed by a predetermined distance or longer for a predetermined period of time and in which the trailing game medium is approaching the certain game medium. A third example of the second game-status condition shows a status in which the distance between a certain game medium and a game medium in front thereof in the traveling direction is narrowed by a predetermined distance or longer and in which the certain game medium is overtaking the game medium in front thereof. In the first example, the leading game medium can be set as a first game medium that acts on the basis of action information. In the second example, the certain game medium can be set as a first game medium that acts on the basis of action information. In the third example, the game medium that is overtaking the front game medium can be set as a first game medium that acts on the basis of action information. Furthermore, the second game-status condition can be: (1) a condition that a particular game medium is in a specific status in the game, e.g., entering the gate, an early stage, a middle stage, or a final stage; (2) a condition that a particular game medium has exercised a skill; (3) a condition that a particular game medium was affected by a skill of another game medium; (4) a condition that a particular game medium is in a specific state, e.g., excitement, fear, or being pushed out; (5) a condition that a fundamental-capability parameter of the speed, the stamina, or the like of a particular game medium becomes a predetermined value; (6) a condition that a parameter indicating the type of the game field (background), the weather or the state of the virtual space, or the like becomes a predetermined value; (7) a condition that a reuse-prohibited flag is not set for game production information, in a game in which, when game production information is once processed, a reuse-prohibited flag is set for that game production information by, for example, the game control unit 23; or a combination of at least two of these conditions. In this way, a plurality of second game-status conditions are set, and a first game medium to be decided and each of the second game-status conditions are stored in association with each other.

The game status can be determined by the first-game-medium decision unit 23g on the basis of game-status information including at least location information of the individual game media. That is, the first-game-medium decision unit 23g decides a first game medium on the basis of the game-status information including location information of the game media. More specifically, the first-game-medium decision unit 23g determines the game status on the basis of the game-status information, decides a first game medium associated with the second game-status condition in the case where it is determined that the game status satisfies the second game-status condition, decides action information associated with the second game-status condition, and reads the action information from the storage device 14. Note that the first-game-medium decision unit 23g does not execute any special calculation in the case where it is determined that the game status does not satisfy the second game-status condition, on the basis of the game-status information.

The action information is information related to an action of a game medium and is a kind of the motion change information. The action information can include at least one piece of first action information. The first action information is data indicating a change in action of the face or the eyes of a game medium, i.e., the direction of the face or the movement of the line-of-sight. The first action information corresponds to a positional relationship between game media. Specifically, the first action information includes information indicating an action of directing at least a part of a first game medium toward a second game medium, to be described later, and may include information indicating an action of returning to the original state from that action. The part of a first game medium can be a part of the first game medium enabling the first game medium to detect another game medium and/or a part of the first game medium related to the detection. The part of a game medium enabling to detect another game medium can be, for example, the eyes, a sensor, a tentacle, an antenna, a radar, or the like of the game medium. The part of a game medium related to the detection is a part that supports the part of the game medium enabling to detect another game medium and can be, for example, the face, the head, the body, or the like of the game medium. More specifically, the first action information can indicate an action of turning to the left, the right, and/or the rear side, with the first game medium used as the reference, and a glance motion and an action of returning to the original state after the glance motion, set for each game medium. Note that the action information may not necessarily be directly associated with the first game medium, and it is only necessary that the first game medium and the action information are associated with the second game-status condition.

The second-game-medium decision unit 23h is configured by including the processor 11 and decides a second game medium from the plurality of game media on the basis of location information of the first game medium in the virtual space of the game. Specifically, the second-game-medium decision unit 23h decides a second game medium on the basis of the place of the first game medium during the progression of the game. In one example, the second-game-medium decision unit 23h decides, as a second game medium, a game medium that is one place lower than the first game medium. Note that, in the case where the first game medium is in the last place, the second-game-medium decision unit 23h does not have to decide a second game medium because there are no game media in a place lower than the first game medium, or may decide, as a second game medium, one of the used game media at random. In another example, the second-game-medium decision unit 23h decides, as a second game medium, one of game media located within a predetermined range of the first game medium. For example, the second-game-medium decision unit 23h may decide a game medium that is closest to the first game medium, as a second game medium, or may decide, among game media that are closest to the first game medium, one of game media located at the left side, the right side, and/or the rear side, as a second game medium.

The position identifying unit 23i is configured by including the processor 11 and identifies the positional relationship between the first game medium and the second game medium in the virtual space. The identified positional relationship is, for example, a positional relationship in which the second game medium is located at the left, the right, and/or the rear side when viewed from the first game medium. The position identifying unit 23i can identify the positional relationship between the first game medium and the second game medium on the basis of the game-status information. The position identifying unit 23i can identify the right/left positional relationship depending on whether the race is executed in a counterclockwise course or in a clockwise course, or whether the second game medium is located more inward or outward than the first game medium.

The determination unit 23j is configured by including the processor 11 and determines whether the first action information corresponding to the positional relationship identified by the position identifying unit 23i is included in the action information decided by the first-game-medium decision unit 23g.

For example, in the case where the decided action information includes a glance motion of turning to the left, and the positional relationship is identified in which the second game medium is located at the left side or the left rear side of the first game medium, the determination unit 23j determines that the first action information corresponding to the positional relationship is included in the action information. In the case where the decided action information includes a glance motion of turning to the left, and the positional relationship is identified in which the second game medium is located at the right side or the right rear side of the first game medium, the determination unit 23j determines that the first action information corresponding to the positional relationship is not included in the action information.

Furthermore, in the case where the decided action information includes a glance motion of turning to the right, and the positional relationship is identified in which the second game medium is located at the right side or the right rear side of the first game medium, the determination unit 23j determines that the first action information corresponding to the positional relationship is included in the action information. In the case where the decided action information includes a glance motion of turning to the right, and the positional relationship is identified in which the second game medium is located at the left side or the left rear side of the first game medium, the determination unit 23j determines that the first action information corresponding to the positional relationship is not included in the action information.

Furthermore, in the case where the decided action information includes a glance motion of turning to the left side, the right side, or the rear side, and the positional relationship is identified in which the second game medium is located at the front side of the second game medium, the determination unit 23j determines that the first action information corresponding to the positional relationship is not included in the action information. For example, in the case where the first game medium is in the last place, it is assumed that the first game medium does not turn around. However, even in the case where the first game medium is in the last place, when the positional relationship is identified in which the second game medium is located at the left, right, left front or right front side of the first game medium, it is possible to execute a glance motion if the first action information corresponding to the positional relationship is included in the action information.

The game presentation processing unit 23d executes processing of presenting the game on the basis of the game-status information. At this time, on the basis of the game production information, which is decided by the production-information decision unit 23e, and the action-related information on a game medium, which is decided by the action-related-information decision unit 23f, the game presentation processing unit 23d processes the game production information and causes the game medium to act on the game screen. Specifically, the game presentation processing unit 23d treats the game-status information, the decided game production information, and the decided action-related information as input data, generates presentation information, such as a game screen and sound, to be presented to the player, on the basis of these pieces of input data, and outputs the presentation information to the output device 13.

The game presentation processing unit 23d draws, on the game screen, the game while treating a game medium associated with the game production information as an attention target. In one example, in the case where the game production information indicates that “the 2nd-place used game medium j is trying to overtake the leading used game medium i!”, the game presentation processing unit 23d treats the 2nd-place used game medium j as an attention target. Furthermore, the game presentation processing unit 23d may draw a game medium treated as an attention target on the game screen on the basis of virtual-camera information. The virtual-camera information is information including location information of a virtual camera and the orientation thereof in the virtual space of the game, with the attention-target game medium used as the reference. Specifically, the virtual-camera information can include the relative-position coordinates of the virtual camera with the attention-target game medium used as the reference, the orientation thereof, the angle of view thereof, the FOV (Field of View) thereof, the movement thereof, rotation thereof at the relative-position coordinates, and a blur or vibration thereof for producing a screen shake. For example, the virtual-camera information can include the position on the left, the right, and/or the front side of the attention-target game medium and the direction from that position toward the attention-target game medium. Movement of the virtual camera can be, for example, movement of the race in the traveling direction, i.e., movement to follow the attention-target game medium. In the example shown in FIGS. 5 and 6, the leading game medium is treated as an attention-target game medium, and the virtual camera focuses on the leading game medium.

The virtual-camera information may also include two or more pieces of virtual-camera information. For example, when the virtual-camera information includes pieces of virtual-camera information on two virtual cameras, it is possible to set two regions in one game screen and to include and display attention-target game media of the corresponding virtual cameras in the individual regions, whereby the game can be enjoyed from two points of view in the same game status.

Note that the game presentation processing unit 23d does not execute an action in which an attention-target game medium turns away from the relative position and the orientation of a virtual camera. For example, in the case where a virtual camera is located at the left side of an attention-target game medium, the attention-target game medium may turn to the left side but does not turn to the right side. In one example, in order that the attention-target game medium does not turn away from the virtual camera, the action information and the virtual-camera information are managed in association with each other in a one-to-one manner (for example, the action information and the virtual-camera information are stored in the storage device 14 in association with each other). For example, even when a motion of turning to the left side is set with respect to the virtual-camera information in which the virtual camera is located at the left side of the attention-target game medium, it is possible not to set a motion of turning to the right side. In another example, even when the first action information corresponding to the positional relationship is included in the action information, if it is determined that the attention-target game medium turns away from the virtual camera due to the action of the first action information, on the basis of virtual-camera information, the game presentation processing unit 23d does not execute or invalidates the processing of the first action information.

FIG. 5 shows one example of a game screen G2 generated by the game presentation processing unit 23d, which is also one example of the game screen G2 generated before a motion change. FIG. 6 shows one example of the game screen G2 generated by the game presentation processing unit 23d, which is also one example of the game screen G2 generated after the motion change.

As shown in FIGS. 5 and 6, the game screen G2 includes and displays a positional-relationship display region R21, a game-status display region R22, a provisional-place display region R23, and a live-report/commentary caption-information display region R24.

The positional-relationship display region R21 is a region where positional relationships among the individual used game media are shown. The positional relationships can be decided by the game presentation processing unit 23d on the basis of the game-status information.

The game-status display region R22 is a region where a game medium treated as an attention target and its surroundings are drawn on the basis of the game-status information or the game-status information, the game production information, and the action-related information. In the example shown in FIGS. 5 and 6, a state in which a leading game medium O1 is running alone, and a trailing game medium O2 is following the game medium O1 is drawn. Specifically, the game presentation processing unit 23d reads objects of the corresponding individual game media from the storage device 14 on the basis of the game-status information indicating this state, and displays the individual game media in the game-status display region R22, as shown in FIG. 5.

The provisional-place display region R23 is a region where the provisional place of the used game medium of the player is displayed. The provisional place is place information calculated by the game presentation processing unit 23d on the basis of place information included in the game-status information or the location information, the speed information, etc., of the used game medium of the player included in the game-status information. In the example shown in FIGS. 5 and 6, the provisional place is the 1st-place out of 18 game media. The live-report/commentary caption-information display region R24 is a region where live-report/commentary caption information that is one of the game production information based on the game-status information is displayed. The game presentation processing unit 23d can cause the output device 13 (display device) to display, in the live-report/commentary caption-information display region R24, text information indicating a live report given by the reporter of the racing game and/or text information indicating a commentary given by the commentator of the racing game, these pieces of text information being decided by the production-information decision unit 23e.

In the example shown in FIG. 5, the leading game medium O1 treated as an attention target is going straight in the traveling direction X. In the example shown in FIG. 6, the leading game medium O1, which is treated as an attention target, is turning its face F and eyes E toward the left rear side. In the example shown in FIGS. 5 and 6, in the case where the game status is changed from the state of FIG. 5, in which the leading game medium O1 is running alone, to the state of FIG. 6, in which the 2nd-place game medium O2 has reduced the distance to the top, the game presentation processing unit 23d processes live-report/commentary sound information and live-report/commentary caption information (for example, “the leading used game medium j is running alone!” by the reporter, “but the 2nd-place used game medium i is following!” by the commentator) that indicate this change, on the basis of the decided game production information and the decided action-related information, outputs sound and text that indicate this change to the output device 13 (the display device and the audio device) respectively, and executes a glance motion of turning the face F and the eyes E of the leading game medium O1 toward the left rear side, in accordance with the game production information. At this time, it is also possible to output, to the output device 13 as the texture change information, an effect K in which the leading game medium O1 cuts the wind, as shown in FIGS. 5 and 6, and/or a turning blur L caused by the glance motion, shown in FIG. 6.

When the game production information is not being processed (for example, playback of sound data or display of text data is not being executed), the game presentation processing unit 23d processes a predetermined number of pieces of (for example, one piece of) game production information. In other words, the game presentation processing unit 23d determines whether a predetermined number of pieces of game production information is being processed. In the case where it is determined that the predetermined number of pieces of game production information is not being processed, the game presentation processing unit 23d can process new game production information decided by the production-information decision unit 23e. That is, one piece of game production information is processed by taking a predetermined period of time, and different kinds of pieces of game production information are not processed at the same time but are serially processed over time. The reason why the number of pieces of game production information to be processed in the predetermined period of time is limited to one in this way is to prevent game production information that indicates another game status from being processed and output. However, one piece of game production information may include sound data and/or text data of the reporter and the commentator, corresponding to one game status. In the case where it is determined that game production information is being processed, the game presentation processing unit 23d executes processing of the game production information until that processing is finished, without processing another piece of game production information in parallel.

In the case where the determination unit 23j determines that first action information is included in the decided action information, the game presentation processing unit 23d causes the decided first game medium to act on the game screen on the basis of the first action information. In one example, the game presentation processing unit 23d executes a glance motion, as shown in FIG. 6. In another example, the game presentation processing unit 23d causes the first game medium to act on the basis of the first action information at the timing corresponding to the game production information decided by the production-information decision unit 23e. The timing corresponding to the game production information is, for example, the timing of output of the corresponding sound or caption from the output device 13. Specifically, in the case where the game production information indicates that “the leading used game medium j is running alone!”, the game presentation processing unit 23d processes the first action information (glance motion) corresponding to the positional relationship and causes the first game medium to act in accordance with the first action information, at the timing of output of the corresponding sound or caption from the output device 13.

The game presentation processing unit 23d decides the individual places of the plurality of game media during the progression of the game on the basis of location information of the plurality of game media in the virtual space of the game. That is, the game presentation processing unit 23d decides the places of the used game media at each virtual time during the progression of the game on the basis of the game-status information. These places are provisional places during the progression of the game, change from moment to moment, and are determined when the used game media reach the goal point.

As described above, player's operations are not required for the processing procedures of the game execution unit 23c, the game presentation processing unit 23d, the production-information decision unit 23e, the action-related-information decision unit 23f, the first-game-medium decision unit 23g, the second-game-medium decision unit 23h, the position identifying unit 23i, and the determination unit 23j. In other words, the processing procedures of these units are automatically executed.

### Operation

### Operation Overview

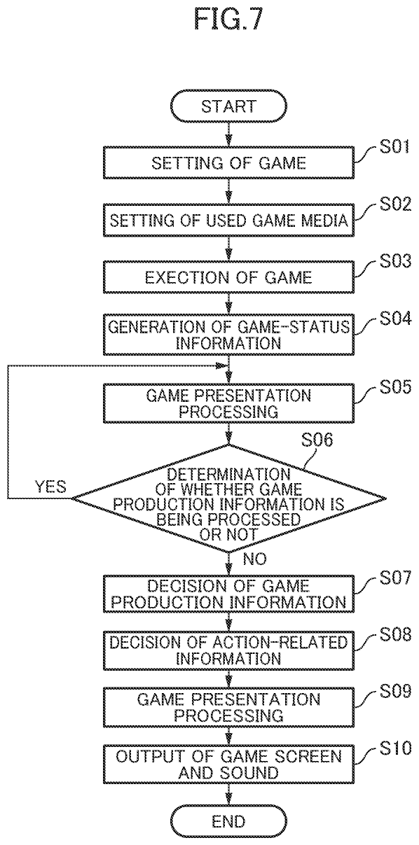

FIG. 7 shows one example of an operation flowchart, related to a production and an action, of the information processing device according to the embodiment of the present invention. As shown in FIG. 7, first, in the information processing device 10, the game setting unit 23a accepts a player's selection of a game and sets the accepted game as a game to be executed by the game execution unit 23c (S01).

Next, the game-medium setting unit 23b accepts setting of used game media to be made to participate in the set game (S02). The game execution unit 23c executes the game on the basis of the set game, the set used game media, and characteristic information of the set used game media (S03), and generates game-status information serving as an execution result of the game (S04).

The game presentation processing unit 23d executes processing of presenting the game on the basis of the generated game-status information (S05). That is, the game presentation processing unit 23d generates information of a game screen to be displayed, on the basis of the generated game-status information, and displays the game screen, which indicates the game in progress, on the output device 13 (the display device).

The game control unit 23 determines whether the game production information is being processed by the game presentation processing unit 23d (S06). In the case where it is determined that game production information is being processed (YES in S06), the flow returns to Step S05. In the case where it is determined that game production information is not being processed (NO in S06), the production-information decision unit 23e decides game production information on the basis of the game-status information generated in Step S04

(S07). Specifically, the production-information decision unit 23e determines whether the game status satisfies the first game-status condition, on the basis of the game-status information, decides game production information corresponding to the first game-status condition in the case where the game status satisfies the first game-status condition, and reads the decided game production information from the storage device 14 in accordance with a first table in which the first game-status condition and the game production information are associated, for example.

Next, the action-related-information decision unit 23f decides action-related information associated with the decided game production information (S08). Specifically, the action-related-information decision unit 23f decides action-related information associated with the decided game production information, from the decided game production information and a second table in which the game production information and the action-related information are associated, and reads the action-related information from the storage device 14.

The game presentation processing unit 23d executes processing of presenting the game on the basis of the game-status information, the decided game production information, and the decided action-related information (S09). That is, the game presentation processing unit 23d generates presentation information, such as a game screen and sound, to be presented to the player, on the basis of these pieces of information, and outputs the presentation information to the output device 13 (S10).

The processing procedures from Step S05 to Step S10 are repeatedly executed until the game is finished, and, when presentation of the game-status information is performed to the end, the game is finished.

### Motion Change

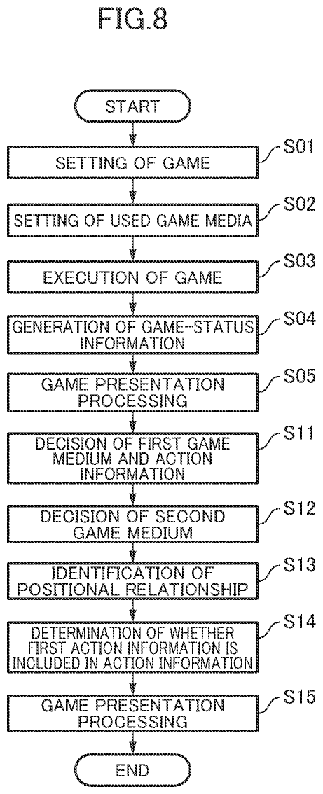

FIG. 8 shows one example of an operation flowchart, related to a motion change, of the information processing device according to the embodiment of the present invention. Note that, since Steps S01 to S05 in FIG. 8 are the same as Steps S01 to S05 in FIG. 7, a detailed description thereof will be omitted.

The first-game-medium decision unit 23g decides, among the plurality of game media used in the game, a first game medium to be displayed on the game screen and action information, on the basis of a predetermined condition (S11). Specifically, the first-game-medium decision unit 23g determines whether the game status satisfies the second game-status condition, on the basis of the game-status information generated in Step S04. In the case where it is determined that the game status does not satisfy the second game-status condition, the first-game-medium decision unit 23g does not execute any special calculation, and the flow returns to Step S05. In the case where it is determined that the game status satisfies the second game-status condition, the first-game-medium decision unit 23g decides a first game medium and action information on the basis of the satisfied second game-status condition and third and fourth tables in which the second game-status condition is associated with the first game medium and with the action information.

The second-game-medium decision unit 23h decides a second game medium from among the plurality of game media on the basis of location information of the first game medium in the virtual space of the game (S12). Here, the second-game-medium decision unit 23h decides, as a second game medium, a game medium that is one place lower than the first game medium. Note that, in the case where the first game medium is in the last place, the second-game-medium decision unit 23h need not decide a second game medium. In this case, for example, the flow returns to Step S05. In this case, the first game medium does not perform an action based on the action information. In Step S12, in the case where the first game medium is not in the last place, the second-game-medium decision unit 23h decides, as a second game medium, a game medium that is one place lower than the first game medium.

The position identifying unit 23i identifies the positional relationship between the first game medium and the second game medium in the virtual space (S13). Next, the determination unit 23j determines whether the first action information corresponding to the positional relationship identified by the position identifying unit 23i is included in the action information decided by the first-game-medium decision unit 23g (S14).

In the case where the determination unit 23j determines that the first action information is included in the decided action information, the game presentation processing unit 23d causes the decided first game medium to act on the game screen on the basis of the first action information (S15). In one example, an action of turning the face and the eyes, of the leading game medium in FIG. 5 facing straight in the traveling direction, toward the left rear side is drawn on the game screen, as shown in FIG. 6, and an action of returning to the original state so as to make the face and the eyes face straight in the traveling direction, as shown in FIG. 5, again is performed. By executing the glance motion and the returning action in this way to implement a production effect of being concerned about the state of the game medium behind, it possible to enhance the sense of presence in the game.

### Operation/Effect

(1) The information processing device 10 of this embodiment is an information processing device that executes a game in which one or more game media participate, the information processing device including: the game presentation processing unit 23d, which executes processing of presenting the game on the basis of game-status information of the game; the production-information decision unit 23e, which decides game production information indicating game development on the basis of the game-status information of the game; and the action-related-information decision unit 23f, which decides action-related information serving as information related to an action of a game medium that is associated with the game production information. When executing the processing of presenting the game, the game presentation processing unit 23d processes game production information and causes the game medium to act on the game screen, on the basis of the game production information and the action-related information on the game medium.

Accordingly, the game medium associated with the production can be made to act in accordance with a production effect of the game based on the game status; therefore, it is possible to match the timing of the production effect of the game and that of the action of the game medium, thus making it possible to enhance the sense of presence in the game.
(2) The game production information is made to include sound information or caption information on the game. Accordingly, the player can understand the game status with sound or text, thus making it possible to enhance the sense of presence in the game.
(3) The game-status information is made to include location information of the one or more game media in the virtual space of the game per unit time. Accordingly, it is possible to execute a production effect and an action corresponding to the game status, which changes from moment to moment, thus making it possible to enhance the sense of presence in the game.
(4) The game presentation processing unit 23d is configured to decide the individual places of the one or more game media during the progression of the game on the basis of the game-status information. Accordingly, it is possible to execute a production effect and an action corresponding to the game status, which changes from moment to moment, thus making it possible to enhance the sense of presence in the game.
(5) The action-related information on the game medium is made to include motion change information on the game medium, expression change information thereon, texture change information thereon, or a combination of at least two of these pieces of information. Accordingly, since a change of the game medium matched to the game production information can be shown on the game screen, it is possible to further enhance the sense of presence in the game.
(6) The game presentation processing unit 23d is configured to draw the game on the game screen, with the game medium that is associated with the game production information being treated as an attention target. Accordingly, since the game medium matched to the game production information is drawn on the game screen, it is possible to further enhance the sense of presence in the game.
(7) The game presentation processing unit 23d is configured to draw the game medium that is associated with the game production information, on the game screen on the basis of virtual-camera information including the location information and the orientation of a virtual camera in the virtual space of the game, which are determined with the game medium used as the reference. Accordingly, since a game screen in which the attention-target game medium is focused can be drawn, the player can easily recognize the attention-target game medium, and it is possible to enhance the sense of presence and the sense of immersion in the game.
(8) The game presentation processing unit 23d is configured to process, when not processing the game production information, a predetermined number of pieces of the game production information. Accordingly, since only one piece of game production information is processed in a predetermined period of time corresponding to the game status, the player can pay attention to the attention-target game medium corresponding to the game status, thus making it possible to enhance the sense of immersion.
(9) The information processing device 10 of this embodiment is an information processing device that executes a game in which a plurality of game media participate, the information processing device being configured by including: the first-game-medium decision unit 23g, which decides, among the plurality of game media, a first game medium to be displayed on the game screen and action information related to an action of the game medium, on the basis of a predetermined condition; the second-game-medium decision unit 23h, which decides a second game medium from among the plurality of game media on the basis of location information of the first game medium in the virtual space of the game; the position identifying unit 23i, which identifies the positional relationship between the first game medium and the second game medium in the virtual space; the determination unit 23j, which determines whether first action information corresponding to the positional relationship is included in the action information; and the game presentation processing unit 23d, which causes the first game medium to act on the game screen on the basis of the first action information, in the case where the first action information is included in the action information.

Accordingly, since the first game medium can be made to perform an action suited to the positional relationship between the first game medium and the second game medium, it is possible to enhance the sense of presence in the game. Furthermore, in the case where it is determined that the first action information corresponding to the positional relationship is not included in the action information, on the basis of the determination result of the determination unit 23j, the game presentation processing unit 23d does not execute an action based on the first action information, thereby making it possible to maintain consistency with the game status.
(10) The information processing device 10 includes the production-information decision unit 23e, which decides game production information associated with one or more game media on the basis of the game-status information including location information. The game presentation processing unit 23d is configured to causes the first game medium to act at the timing corresponding to the game production information on the basis of the first action information.

Accordingly, since the associated first game medium can be made to act in accordance with the game production information, it is possible to match the timing of the production and that of the action, thus making it possible to further enhance the sense of presence in the game.
(11) The first action information is made to include information indicating an action of turning at least a part of the first game medium toward the second game medium and returning it to the original state.

Accordingly, it is possible to present to the player that the first game medium pays attention to the second game medium many times, thus making it possible to further enhance the sense of presence in the game.
(12) The game presentation processing unit 23d is configured to decide the individual places of the plurality of game media during the progression of the game on the basis of the location information of the plurality of game media in the virtual space of the game. Accordingly, a production effect and an action corresponding to the game status, which changes from moment to moment, can be executed, thus making it possible to enhance the sense of presence in the game.
(13) The second-game-medium decision unit 23h is configured to decide a second game medium on the basis of the place of the first game medium during the progression of the game. Accordingly, a game medium that attracts attention in situation where the game status intensifies can be decided as a second game medium, e.g., a game medium that is one place lower than the first game medium is decided as a second game medium, thus making it possible to further enhance the sense of presence in the game.
(14) The first-game-medium decision unit 23g is configured to decide a first game medium on the basis of the game-status information including location information. Accordingly, a game medium that attracts attention in a situation where the game status intensifies can be decided as a first game medium, thus making it possible to further enhance the sense of presence in the game.

### Embodiment Realized By System

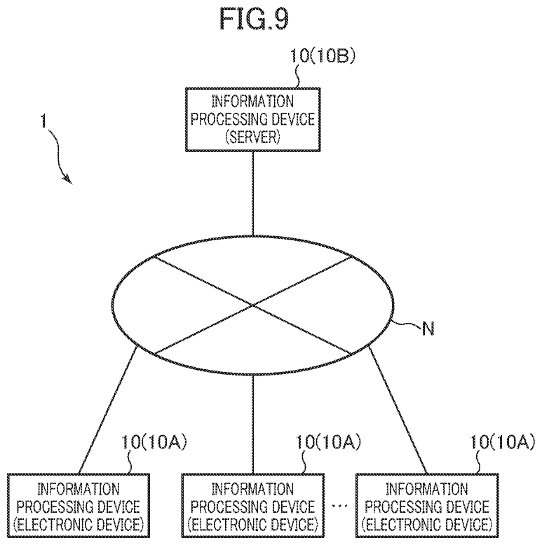

FIG. 9 is a view showing one example of the overall configuration of a game system according to an embodiment of the present invention. As shown in FIG. 9, a game system 1 includes a plurality of information processing devices 10. Among the plurality of information processing devices 10, at least one of them is a server 10B, and the rest information processing devices 10 are electronic devices 10A serving as user terminals used by individual players. The electronic devices 10A and the server 10B are connected to a network N such as the Internet so as to be able to communicate with each other. Note that, although the game system 1 of this embodiment will be described on the assumption that the game system 1 is a server-client system, it is also possible to configure the game system 1 with a system, like PtoP, that does not include the server 10B.

The electronic devices 10A and the server 10B each include the same hardware configuration as that shown in FIG. 1, and the electronic devices 10A are smartphones also in this embodiment. The server 10B is a server device that provides a game executable in the electronic devices 10A, and is configured by one or a plurality of computers.

The server 10B stores various programs, such as a control program for controlling progression of an online game, and various kinds of data to be used in the game.

In one example, the server 10B is configured to provide, to the electronic devices 10A, a game application executable in the electronic devices 10A. When the game application is downloaded and executed, the electronic devices 10A send and receive data to and from the server 10B regularly or as needed, to proceed with the game. For example, the server 10B stores various kinds of setting information, history information, etc. required for the game executed in the electronic devices 10A. In this case, each of the electronic devices 10A has the input unit 21, the output unit 22, the game control unit 23, and the individual function units in the game control unit 23 except the game execution unit 23c. The server 10B has the function of the game execution unit 23c. That is, the server 10B receives a game and used game media that have been respectively set at the game setting unit 23a and the game-medium setting unit 23b of the electronic device 10A, the game execution unit 23c of the server 10B executes the game on the basis of the game and the used game media and generates game-status information. Then, the electronic device 10A executes processing procedures of the individual function units 23d to 23j based on the game-status information received from the server 10B. The game-status information may be sent from the server 10B to the electronic device 10A per unit time, or game-status information for one game generated at the server 10B may be sent to the electronic device 10A.

In one example, the server 10B is a web server and provides a game service to the electronic devices 10A. Each of the electronic devices 10A obtains HTML data for displaying a web page from the server 10B, and analyzes the obtained HTML data to display the web page. In this case, the server 10B, which communicates with each of the electronic devices 10A, has the entirety or a portion of the function of the game control unit 23. For example, the electronic devices 10A each accept player's settings of a game and game media via the input unit 21 (the input device 12), and the game execution unit 23c of the server 10B executes the game and generates game-status information. Furthermore, the server 10B executes processing of the entirety or a portion of the function units 23d to 23j based on the generated game-status information, and generates presentation information including a game screen and/or sound etc. Then, each of the electronic devices 10A outputs the presentation information to the output device 13 of the electronic device 10A on the basis of the presentation information received from the server 10B.

### Other Embodiments

According to another embodiment of the present invention, it is also possible to provide a program that realizes the functions and the information processing shown in the flowcharts of the above-described embodiment of the present invention and a computer-readable storage medium that has stored the program. Furthermore, according to still another embodiment, it is also possible to provide a method that realizes the functions and the information processing shown in the flowcharts of the above-described embodiment of the present invention. Furthermore, according to still another embodiment, it is also possible to provide a server that can supply, to a computer, a program that realizes the functions and the information processing shown in the flowcharts of the above-described embodiment of the present invention. Furthermore, according to still another embodiment, it is also possible to provide a virtual machine that realizes the functions and the information processing shown in the flowcharts of the above-described embodiment of the present invention.

The processing or operation described above can be modified freely as long as no inconsistency arises in the processing or operation, such as an inconsistency that a certain step utilizes data that may not yet be available in that step. Furthermore, the examples described above are examples for explaining the present invention, and the present invention is not limited to those examples. The present invention can be embodied in various forms as long as there is no departure from the gist thereof.

For example, in the above-described embodiments, although the game is a racing game, the game may also be a sports match game or a fighting match game. In this case, game production information may be information indicating the development, the progression, and/or the status of the game, and may include sound information or caption information indicating a shout of joy and cheering, in addition to live-report/commentary sound information or live-report/commentary caption information.

Furthermore, the game may also be an action game in which a game medium is made to act through a player's operation. In this case, with the configurations of the individual units, it is possible to cause a motion change automatically independently of the player's operation. For example, in the case of an action game using guns, if game production information indicates that “an ally game medium is shot!”, it is possible to decide action-related information on an action of turning toward that direction on the basis of the game production information and to execute the action of turning to that direction, thus making it possible to enhance the sense of presence in the game. Furthermore, with an event in which a second game medium located within a predetermined range of a first game medium is shot being used as a trigger, it is possible to execute an action of making the first game medium turn toward the second game medium, with the configurations of the individual units, thus making it possible to enhance the sense of presence in the game. In this way, the present invention can be applied to an action game, in addition to a game that progresses automatically as in the embodiment.

Furthermore, in the above-described embodiment, although a description has been given of a racing game, such as a horse-racing game, in which characters run by themselves, it is also possible to adopt a racing game in which characters travel by riding in vehicles, such as cars, bicycles, motorbikes, or karts.

### Reference Signs List

1 game system
10 information processing device
10A electronic device
10B server
11 processor
12 input device
13 display device
14 storage device
15 communication device
16 bus
21 input unit
22 output unit
23 game control unit
23a game setting unit
23b game-medium setting unit
23c game execution unit
23d game presentation processing unit
23e production-information decision unit
23f action-related-information decision unit
23g first-game-medium decision unit
23h second-game-medium decision unit
23i position identifying unit
23j determination unit
E eye of leading game medium
F face of leading game medium
G1 game-media selection screen
G2 game screen
N network
O1 leading game medium
O2 trailing game medium

1. A non-transitory computer readable medium storing a program for a game in which one or more game media participate, the program causing a computer to function as:
a game presentation processing means that executes processing of presenting the game on the basis of game-status information of the game;
a production-information decision means that decides game production information indicating game development on the basis of the game-status information of the game; and
an action-related-information decision means that decides action-related information serving as information related to an action of any of the one or more game media that is associated with the game production information,
wherein, when executing the processing of presenting the game, the game presentation processing means processes the game production information and causes said any of the one or more game media to act on a game screen, on the basis of the game production information and the action-related information on said any of the one or more game media.

2. The non-transitory computer readable medium according to claim 1, wherein the game production information includes sound information or caption information on the game.

3. The non-transitory computer readable medium according to claim 1, wherein the game-status information includes location information of said one or more game media in the virtual space of the game per unit time.

4. The non-transitory computer readable medium according to claim 1, wherein the game presentation processing means decides a place of said one or more game media during the progression of the game on the basis of the game-status information.

5. The non-transitory computer readable medium according to claim 1, wherein the action-related information on said any of the one or more game media includes motion change information on said any of the one or more game media, expression change information thereon, texture change information thereon, or a combination of at least two of these pieces of information.

6. The non-transitory computer readable medium according to claim 1, wherein the game presentation processing means draws said any of the one or more game media associated with the game production information, on the game screen on the basis of virtual-camera information including location information and the orientation of a virtual camera in the virtual space of the game, with said any of the one or more game media used as a reference.

7. The non-transitory computer readable medium according to claim 5, wherein, when not processing the game production information, the game presentation processing means processes a predetermined number of pieces of the game production information.

8. The non-transitory computer readable medium according to claim 1, wherein the game-status information includes game-status information for one game, generated in a server.

9. An information processing device that executes a game in which one or more game media participate, the information processing device comprising:
a game presentation processing means that executes processing of presenting the game on the basis of game-status information of the game;
a production-information decision means that decides game production information indicating game development on the basis of the game-status information of the game; and
an action-related-information decision means that decides action-related information serving as information related to an action of any of the one or more game media that is associated with the game production information,
wherein, when executing the processing of presenting the game, the game presentation processing means processes the game production information and causes said any of the one or more game media to act on a game screen, on the basis of the game production information and the action-related information on said any of the one or more game media.

10. A method for an information processing device to execute a game in which one or more game media participate, the method comprising:
a game presentation processing step for executing processing of presenting the game on the basis of game-status information of the game;
a production-information decision step for deciding game production information indicating game development on the basis of the game-status information of the game; and
an action-related-information decision step for deciding action-related information serving as information related to an action of any of said one or more game media that is associated with the game production information,
wherein, in the game presentation processing step, when the processing of presenting the game is executed, the game production information is processed, and said any of the one or more game media is made to act on a game screen, on the basis of the game production information and the action-related information on said any of the one or more game media.

11. A system for executing a game in which one or more game media participate, the system comprising an electronic device and a server connected to the electronic device via a network,
the electronic device or the server functioning as a game presentation processing means that executes processing of presenting the game on the basis of game-status information of the game;
the electronic device or the server functioning as a production-information decision means that decides game production information indicating game development on the basis of the game-status information of the game; and
the electronic device or the server functioning as an action-related-information decision means that decides action-related information serving as information related to an action of any of the one or more game media that is associated with the game production information,
wherein, when executing the processing of presenting the game, the game presentation processing means processes the game production information and causes said any of the one or more game media to act on a game screen, on the basis of the game production information and the action-related information on said any of the one or more game media.
